(19) United States
(12) Patent Application Publication
(10) Pub. No.: US 2005/0051575 A1
(43) Pub. Date: Mar. 10, 2005

(54) Fluid container

(76) Inventor: Gary A. Durivage, Graytown, OH (US)

Correspondence Address: FRASER MARTIN BUCHANAN MILLER LLC, 132C WEST SECOND STREET, PERRYSBURG, OH, 43551-1401, US

(21) Appl. No.: 10/655,786

(22) Filed: Sep. 5, 2003

(51) Int. Cl. B67D 5/60

(52) U.S. Cl. 222/143

(57) ABSTRACT

A fluid container having relatively flat rectangular side walls and a flat circumferential end wall joining the side walls to provide a hollow interior for containing a fluid material with recessed fill/pour spout and handle holes. Tie-down holes are provided to facilitate the stacking and holding down of the containers during storage or transit.

### BACKGROUND OF THE INVENTION

1. Field of the Invention

The present invention relates to a fluid container; and more particularly to a container for transporting and storing liquid fuels, for example.

2. Description of the Prior Art

The prior art containers for transporting and storing liquid fuels include sheet metal containers used in military operations to refuel vehicles, aircraft, tanks, and motorcycles. Such containers are typically constructed to occupy a minimum of space, and are readily adaptable to storage and transportation.

Containers of the type referred to above are disclosed in U.S. Pat. No. 2,387,220 and include structural details enabling containers to be stacked upon one another. The stacking is typically contemplated in a manner wherein the bottom of one container is stacked upon the top of a base container.

U.S. Pat. No. 4,781,314 describes a fluid container wherein the construction assumes a rather box-like housing having diagonal ridges formed in the side walls to increase the structural rigidity of the sides.

The U.S. Pat. No. 3,746,200 to Flider discloses a plastic jerry can having a single filler/pourer opening and a handle to facilitate the carrying thereof. The container is configured to be easily stacked in its upright position.

A modified fluid container is disclosed in U.S. Pat. No. 4,923,098 to Schoonover et al includes a box-like housing which can stand on either end of its two bottoms and can be filled from whichever opening is opposite the bottom on which it stands. The side walls include diagonal ridges to improve structural rigidity of the sides.

While the containers of the prior art are functionally acceptable, it would be desirable to stack the side wall of the container against the side wall of the adjacent without a tendency to collapse the containers, and to include means for tying or entrapping the containers in stacked relation on an associated rack of an all terrain vehicle (ATV), trailer, snowmobile, boat, or backpack, for example, using suitably disposed tie-down holes and handle holes.

### SUMMARY OF THE INVENTION

It is an object of the present invention to produce a fluid container which can be stacked in vertical array side upon side.

Another object of the present invention is to produce a container for fluids provided with spaced apertures to facilitate the use of tie down ropes for securing the array to a supporting rack.

Another object of the present invention is to produce a container for fluids having relatively planar side walls and associated means for preventing the collapse of the side walls when exposed to ancillary forces, at least one pouring/filling aperture in the wall providing communication with the interior of the container.

The above as well objects and advantages of the invention may be achieved by a fluid container comprising a first planar side wall having a circumference defining the shape of the side wall and spaced apart indentations; a second planar side wall having a circumference defining the shape of the wall and spaced apart indentations; and a wall extending circumferentially around and forming the first and second side walls and causing respective ones of the indentations to contact one another to maintain spaced relation across the first and second walls, and to militate against collapse of the walls.

### BRIEF DESCRIPTION OF THE DRAWINGS

The above objects and advantages will be readily apparent and understood by those skilled in the art from reading the following detailed description of the preferred embodiment of the invention when considered in the light of the accompanying drawings, in which:

FIG. 1 is a perspective view of a container embodying the features of the present invention;

FIG. 2 is a front elevational view thereof;

FIG. 3 is a rear elevational view thereof;

FIG. 4 is a left side view thereof;

FIG. 5 is a right side view thereof;

FIG. 6 is a top plan view thereof;

FIG. 7 is a bottom view thereof;

FIG. 8 is a sectional view taken along line 8-8 of FIG. 2;

FIG. 9 is a perspective view of the container illustrated in FIGS. 1-8, with the fill/pour spout removed preparatory to stacking;

FIG. 10 is a perspective view of containers of the type illustrated in FIG. 9 in stacked array;

FIG. 11 is a perspective view of an embodiment of invention shown in FIGS. 1-10 inclusive;

FIG. 12 is a front elevational view thereof;

FIG. 13 is a rear elevational view thereof;

FIG. 14 is a left side view thereof;

FIG. 15 is a right side view thereof; and

FIG. 16 is a perspective view of containers of the type illustrated in FIGS. 12 through 15 in stacked array.

### DETAILED DESCRIPTION OF THE PREFERRED EMBODIMENTS

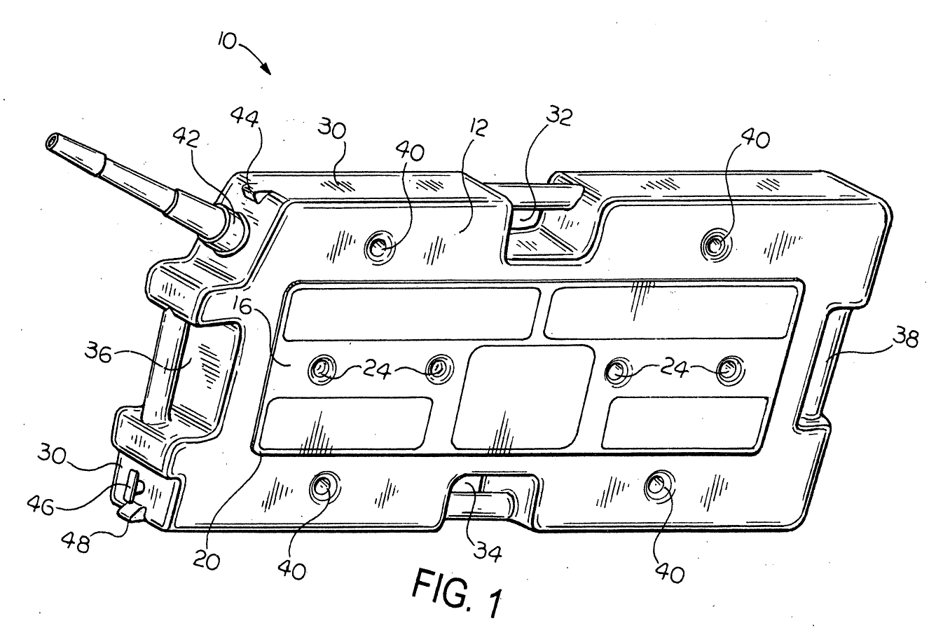

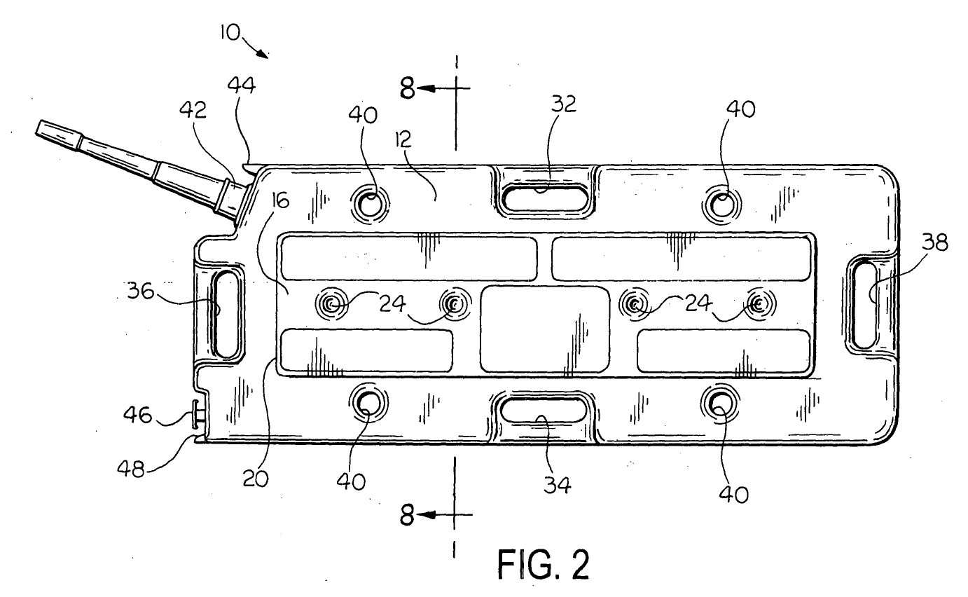

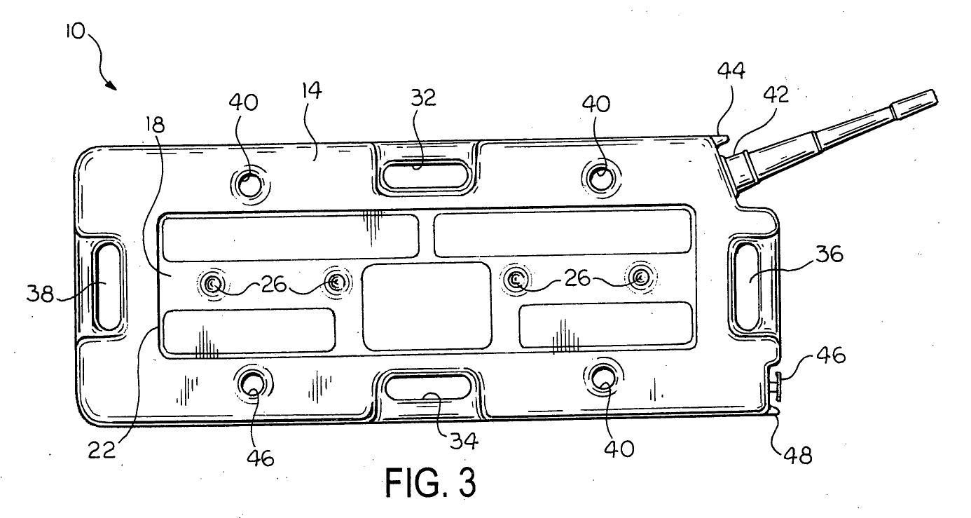

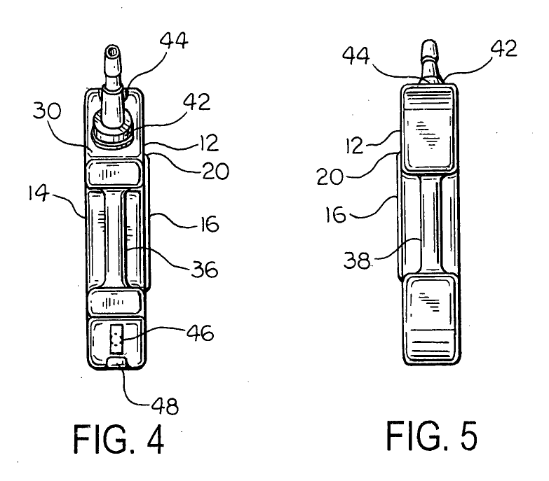

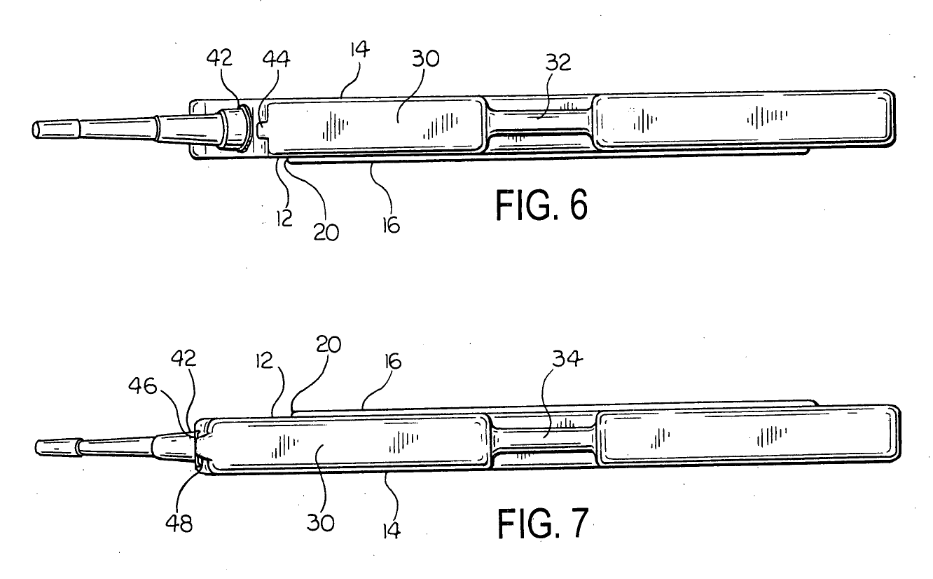

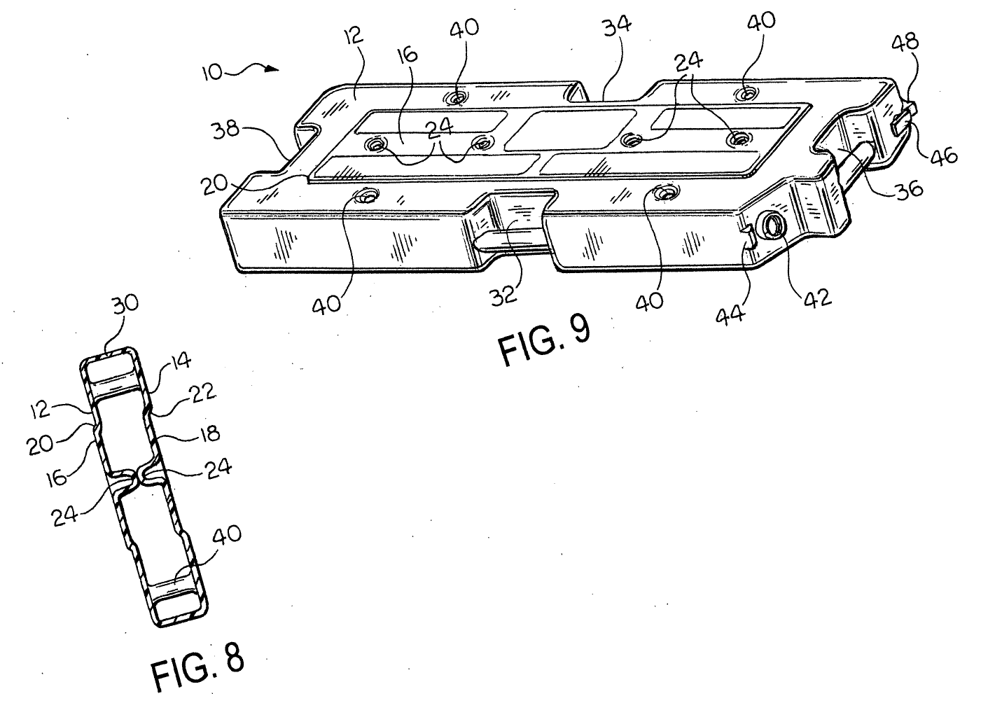

Referring to FIGS. 1 through 10 inclusive of the drawings, there is illustrated a container for fluids incorporating the features of the present invention. The container is generally designated by reference numeral 10 and is comprised of a pair of spaced apart side walls 12 and 14. The side walls 12 and 14 are similar in configuration; however, side wall 12 is provided with a slightly outwardly projecting panel 16, and the side wall 14 is provided with a slightly inwardly projecting panel 18. The outwardly projecting panel 16 is bounded by an outwardly beveled border 20, while the inwardly projected panel 18 is bounded by an inwardly beveled border 22. The panels 16, 18 and the respective beveled borders 20, 22 are utilized to facilitate the stacking of the containers 10, one on top of another as will be explained thereinafter and as illustrated in FIG. 8.

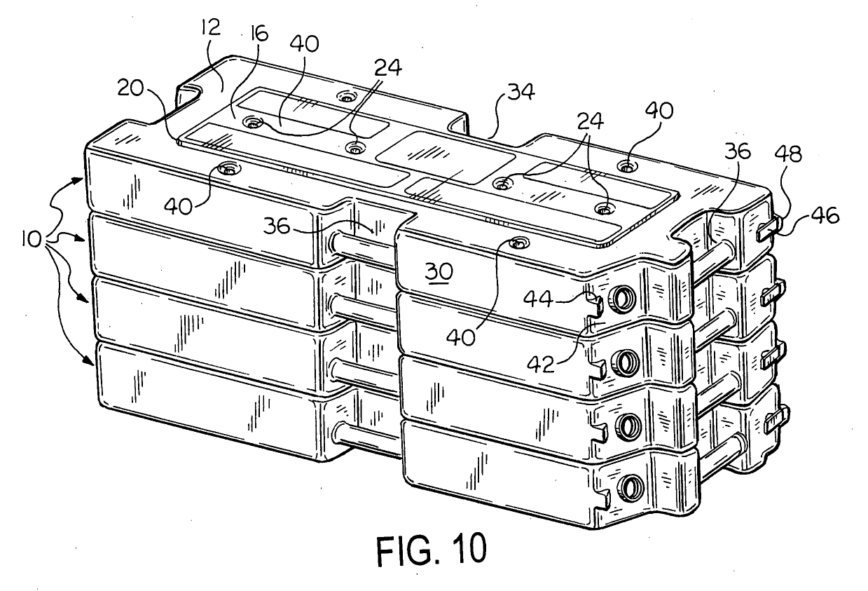

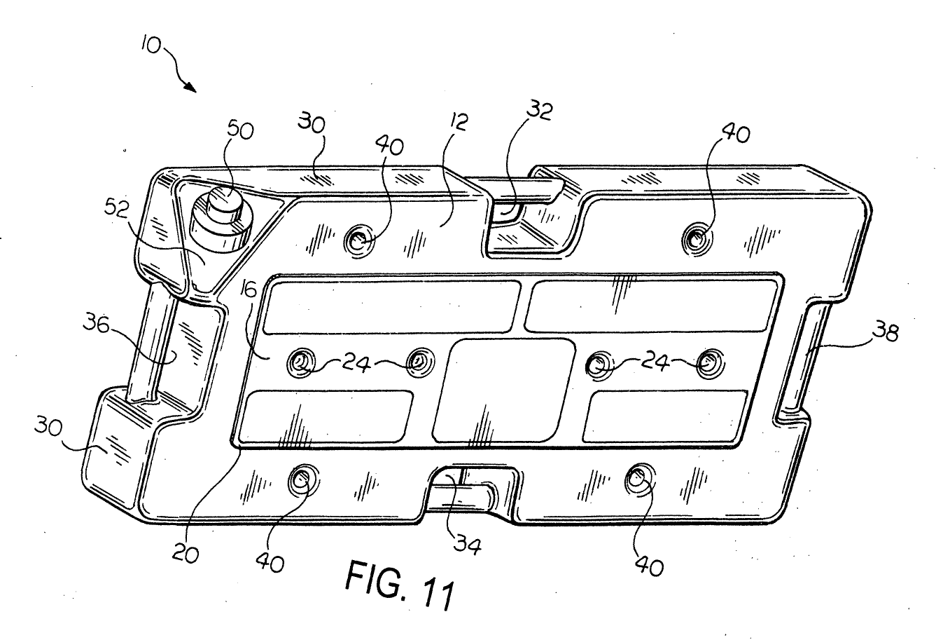

The side wall 12 is provided with a plurality of inwardly projecting indentations 24 which may be frusto-conical in shape, for example. The side wall 14 is provided with a plurality of inwardly projecting indentations 26 which are shaped similarly to the indentations 24 of the side panel 12. The indentations 24 and 26 are spaced apart and arranged so that the innermost end of each of the indentations of one of the side walls 12, 14 contacts the innermost end of a corresponding aligned indentations of the other one of the side walls 12, 14. The reason for the indentations 24 and 26 is to provide for structural strength and stability and to militate against the collapse of the side walls 12 and 14 towards each other when the containers 10 are filled and arranged in stacked relation as illustrated in FIG. 10.

The container 10 is provided with a circumferentially-extending wall 30 which effectively joins the two side walls 12 and 14 to form a generally hollow container 10.

The wall 30 is provided with pairs of opposing recessed handle holes 32, 34, and 36, 38. The handle holes 32, 34, 36, and 38 are positioned generally midway of the longitudinal dimension of the respective portion of the wall 30. Thereby, the lifting of the container by any one of the handle holes will result in a somewhat balanced load to the operator. It will be appreciated that in addition to the handle holes being used for the carrying of the container 10, they are also functional for securing the container to a support with strapping and/or rope. And further, they serve as strengthening elements.

A plurality of spaced apart tie-down holes 40 are formed to extend from the one side wall 12 through the hollow interior of the container 10 to the opposite side wall 14. The holes 40 are defined by hollow cylindrical walls that extend in fluid-tight relation across the hollow interior of the container 10 from side wall 12 to side wall 14. The tie-down holes 40 function as strengthening supports as well as for securing the container 10 with ancillary strapping or ropes.

The container 10 is provided with an integral fill/pour spout 42 having male threads molded therein in the event the container is formed of a plastic material, for receiving the spout. It will be noted that the fill/pour spout 42 is received within a recessed zone protected by a fill/pour spout protection 44. The protection 44 extends a sufficient amount to assist in protecting and militating against any impact to the fill/pour spout 42 from an accidental drop or impact from another object.

A vent 46 and an associated bushing are encapsulated into the material employed to form the circumferentially extending wall 30. The vent 46 and the associated bushing may be formed of a brass material, for example. In order to protect the vent 46, there is provided a projection 48 to protect the zone in which the vent 46 resides. The projection 48 will function to protect the vent 46 from impact which might occur from an accidental drop of the container 10.

It will be noted that the outwardly extending panel 16 and the inwardly extending panel 18 are provided with differing sized engraving faces to allow the use of different interchangeable engraving inserts carrying trademark, capacity, and manufacturer's information, for example. When the containers 10 are employed in stacked array, as illustrated in FIG. 10, the outwardly extending panels 16 are received within the next adjacent and superposed inwardly extending panels 18 of adjacent containers 10. The structural design is such that the associated respective beveled borders 20 and 22 cooperate with one another to facilitate the above referred to stacking of the individual containers 10. Such structure also militates against any relative lateral movement of the stacked container array. Also, it will be understood that suitable tie-down straps or ropes caused to extend through aligned tie-down holes 40 and secured to a supporting rack or the like on a vehicle such as an ATV, for example, are effective to further secure the array of containers 10 until it becomes necessary to empty/fill the containers.

The recessed handle holes 32, 34, 36, and 38 may also be collectively or selectively employed to receive tie-down straps or ropes.

While the container 10 may be fabricated from a number of different materials, it is believed that the use of a high density polyethylene is deemed to have many advantages. The containers 10 may be fabricated by a well-known blow molding process. The typical capacity of the containers 10 is approximately four (4) gallons.

The resultant container product results in one which is easy to carry; may be supported on the side panels as illustrated in FIG. 10, as well as on the edge wall portions since the handle holes 32, 34, 36, and 38 are recessed, and may be readily caused to assume a pouring or filling position.

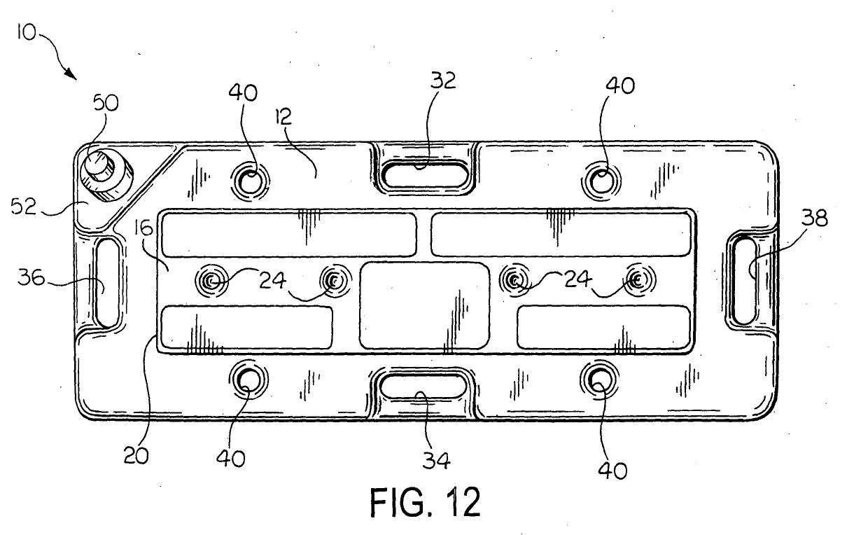

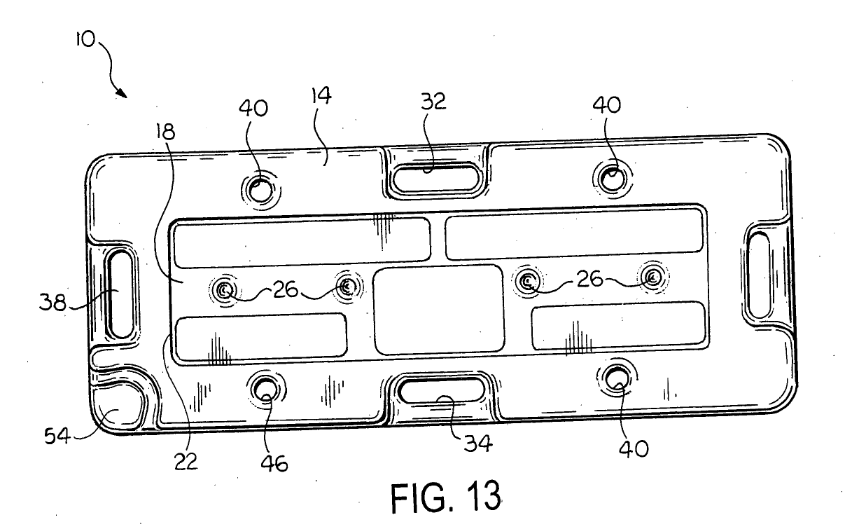

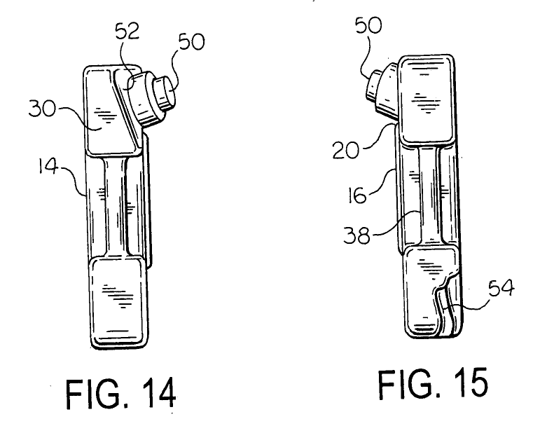

Now referring to FIGS. 11 through 16 inclusive of the drawings, there is illustrated an alternative embodiment of the invention. Most of the features of the container illustrated in FIGS. 11 through 16 are the same as the features illustrated in FIGS. 1 through 10. In order to simplify the description, similar features are indicated with prime reference numerals. The features indicated with prime reference numerals correspond with those similar features previously described and will not be described further hereafter.

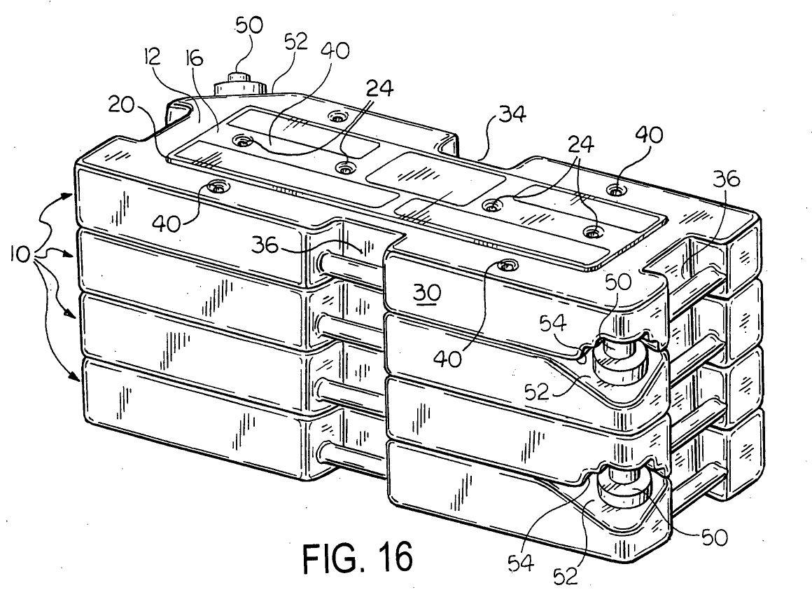

The alternative embodiment has eliminated the side venting feature and has incorporated the pour/fill spout 50 with a recessed section 52 in the left side of the container 10′. A recessed section 54 is formed in a diametrically opposed position from the recessed section 52 in the right side of the container 10′. The recessed section 54 is adapted to receive the pour/fill spout 50 of the next adjacent container 10′, when the containers 10′ are in stacked array as illustrated in FIG. 16.

In accordance with the provisions of the patent statutes, the present invention has been described in what is considered to represent its preferred embodiment. However, it should be understood that the invention can be practiced otherwise than as specifically illustrated and described without departing from its spirit or scope.

1. A fluid container comprising:
a first side wall having spaced apart indentations and a circumference defining the shape of said side wall;
a second side wall having spaced apart indentations and a circumference defining the shape of said side wall; and
a circumferential wall extending around and joining the circumferences of said first and second side walls forming a hollow interior of the container and causing respective ones of the indentations to contact one another to maintain spaced relation across said first and second walls, and militate against collapse of said side walls.

2. A fluid container as defined in claim 1 wherein said indentations are frusto-conical in shape.

3. A fluid container as defined in claim 3 wherein said side walls are planar.

4. A fluid container as defined in claim 3 wherein said side walls are substantially rectangular.

5. A fluid container as defined in claim 4 wherein said side walls and said circumferential wall define spaced apart corners of the container.

6. A fluid container as defined in claim 5 including a fluid fill/pour spout disposed at one said corner.

7. A fluid container as defined in claim 6 wherein said spout provides communication with the hollow interior of the container.

8. A fluid container as defined in claim 7 wherein said spout is recessed within said circumferential wall.

9. A fluid container as defined in claim 7 including a protection extending outwardly from the hollow interior of the container in the region of said spout.

10. A fluid container as defined in claim 7 wherein said side walls and said circumferential wall are formed of a plastic material.

11. A fluid container as defined in claim 10 wherein said plastic is a polyethylene.

12. A fluid container as defined in claim 11 wherein the container is formed by a blow-molding process.

13. A fluid container as defined in claim 7 including at least one tie-down hole extending in fluid-tight relation from said first side wall to said second side wall through the hollow interior of the container.

14. A fluid container as defined in claim 7 including spaced apart handle holes formed in said side walls and said circumferential wall.

15. A fluid container as defined in claim 7 wherein said handle holes are recessed.

16. A fluid container as defined in claim 6 wherein a recess is provided at another of said corners to receive the fill/pour spout of an adjacent one of said container when arranged in stacked relation.

17. A fluid container as defined in claim 1 including a fluid fill/pour spout and a spaced apart recess to receive the fill/pour spout of an adjacent one of said container when arranged in stacked relation.

18. A fluid container as defined in claim 17 wherein said fill/pour spout is inclined in respect of said side walls.

19. A fluid container as defined in claim 18 wherein spaced apart recess is complimentarily inclined in respect of said fill/pour spout of an adjacent one of said container when arranged in stacked relation.

20. A fluid container as defined in claim 5 including a recessed fluid fill/pour spout is disposed at said first side wall.

21. A fluid container as defined in claim 20 including a spaced apart recess disposed at said second side wall to receive the fill/pour spout of an adjacent container when arranged in stacked relation.
